(19) United States
(12) Patent Application Publication
(10) Pub. No.: US 2022/0064411 A1
(43) Pub. Date: Mar. 3, 2022

(54) COMPOUND OR FILM CONTAINING THERMOPLASTIC STARCH AND A THERMOPLASTIC POLYMER

(71) Applicant: AGRANA STÄRKE GMBH, Vienna (AT)

(72) Inventors: Barbara FAHRNGRUBER, Tulln (AT); Marnik Michel WASTYN, Tulln (AT); Martin KOZICH, Tulln (AT)

(21) Appl. No.: 17/419,116

(22) PCT Filed: Dec. 27, 2019
(86) PCT No.: PCT/EP2019/087058

§ 371 Date: Jun. 28, 2021

(30) Foreign Application Priority Data
Dec. 28, 2018 (EP) 18248136.6

(51) Int. Cl. C08L 3/02; C08L 67/02; C08J 5/18; B29C 48/00; B29C 48/08; B29C 48/10; B29C 48/40; B29C 48/76; B29C 48/91

(52) U.S. Cl. CPC C08L 3/02; B29L 2007/008; C08J 5/18; B29C 48/022; B29C 48/0018; B29C 48/08; B29C 48/10; B29C 48/40; B29C 48/767; B29C 48/91; C08L 2203/16; C08L 2207/322; C08L 2205/035; C08L 2201/10; C08J 2367/02; C08J 2467/02; C08J 2403/02; C08J 2303/02; B29K 2003/00; B29K 2995/0026; C08L 67/02

(57) ABSTRACT

The invention relates to a method for producing a compound or a film containing thermoplastic starch, an alpha-hydroxycarboxylic acid ROHCOOH, in which R is CH₂ or CH₃CH₂, in an amount of from 0.1 to 5, preferably 0.1 to 3, particularly preferably 0.1 to 1 wt. % in relation to the thermoplastic starch, and a thermoplastic polymer, in which method the compound or the film is exposed during or after its extrusion to an additional heating step to 100-140° C. A thermoplastic starch usable for the production of the compound, a compound produced by the method, and a transparent film produced from such a compound are also described.

### BACKGROUND OF THE INVENTION

### 1. Field of the Invention

The present invention relates to a method for producing a compound containing thermoplastic starch, and to a film produced from this compound.

### 2. Description of Related Art

According to the conventional definition, thermoplastic starch (hereinafter also referred to as TPS) is an amorphous or semi-crystalline material consisting of digested or destructured starch and one or more plasticisers. TPS may be repeatedly converted into the plastic state and re-hardened, enabling it to be shaped under the action of heat and shear stress, which allows it to be processed using plastics industry techniques. TPS as a material usually has a hydrophilic character, which means that the material properties are strongly dependent on the climatic environmental conditions. For this reason, TPS is rarely used directly or solely for producing bioplastics. The use of finely distributed TPS (disperse phase) in a polymer matrix (continuous phase), on the other hand, offers the possibility of a) considerably increasing the bio-based portion in plastics formulations and b) integrating a biodegradable component, depending on the choice of matrix polymer. Materials which are required to be completely biodegradable or compostable require the use of a polymer matrix which may be decomposed or metabolised in a biological medium and under the action of water by the influence of microorganisms.

Thermoplastic polymers may be melted repeatedly by increasing the temperature. After cooling, they are present in a predominantly crystalline or amorphous structure. This property is used for the purpose of shaping and functions due to the fact that the glass transition temperature (Tg) of thermoplastics is below room temperature. Examples of biodegradable thermoplastic polymers are, for example, polybutylene adipate-co-terephthalate, polycaprolactone, polylactic acid or polybutylene succinate. When processed into a thermoplastic material, the originally semi-crystalline, granular structure is broken up to create a continuous amorphous phase, thus making starch accessible for shaping by conventional plastics processing methods. When heated above the gelatinisation temperature, starch begins to swell in the presence of water. During this process, liquid diffuses into the interior of the grains and ultimately interacts with the free hydroxy groups of the starch molecules. This breaks the hydrogen bonds, the material loses crystallinity, and lastly amorphous areas start to dissolve. The process is fundamentally determined by the temperature curve. Up to a threshold value of approximately 50° C. the procedure is largely reversible. Further heating causes irreversibly strong swelling. The loss of crystallinity causes the starch grains to lose their onion-skin structure and the birefringence visible under microscope, and the viscosity of the suspension increases rapidly. In an extrusion process, plasticisers are also added alternatively to water to achieve the breakdown of the starch under these water-limited conditions. By using plasticisers such as glycerol, sorbitol, erythritol, polyethylene glycol, various mono- and disaccharides or sugar alcohols, intermolecular interactions are reduced, similarly to the effect of water, by breaking the hydrogen bonds between the starch molecules. The procedure in the extruder is accompanied by a splitting of the polymer chains and thus a partial depolymerisation, which causes both the melting and the glass transition temperature to drop below the degradation temperature.

U.S. Pat. No. 5,362,777 discloses the production of thermoplastic starch (TPS) with the addition of plasticisers, for example sorbitol; plant fats may also be added to improve the flow properties.

WO 99/61524 relates to a film made from a thermoplastic polymer mixture containing TPS, at least one polyester urethane, a plasticiser such as sorbitol and oils containing epoxide groups as lubricants, in particular epoxidised linseed oil.

DE 198 24 968 A1 also discloses a film made from a thermoplastic polymer mixture containing TPS with a polymer obtainable by polycondensation or polyaddition, containing plasticisers, for example sorbitol, and plant fats or oils as lubricants.

According to WO 2012/162085 A1, TPS, oil and/or wax (epoxidised plant oil or linseed oil) are disclosed. TPS is a starting product; the presence of another thermoplastic polymer is absolutely necessary for the processing of thermoplastic starch.

Lastly, WO 2006/042364 A1 discloses a mixture of sorbitol and other plasticisers, for example epoxidised linseed oil. Starch is a starting product. Apart from starch, a water-soluble polymer is also present, for example polyvinyl alcohol, polyvinyl acetate or copolymers of ethylene and vinyl alcohol.

The TPS already known from the above-mentioned prior art, despite the addition of plasticisers, is inherently brittle and hydrophilic. Thus, when using pure TPS, the high demands (strength, water resistance) placed on technical products in film extrusion cannot be met.

Due to large differences in viscosity, a fine dispersion of TPS in a polymer matrix is only efficient under high shear (the TPS has a very high viscosity, whereas the polymer tends to have a low viscosity). This may lead to mechanical damage of the TPS phase and an associated brown colouring of the compound material. In addition, the high viscosity of the untreated TPS makes processing more difficult, which is reflected in increased torque and pressure conditions in the extruder.

In addition, the compatibility at the interfaces between the hydrophilic TPS and the hydrophobic polymer is limited. This leads to an impairment of the mechanical material properties (tensile strength, extensibility) and to compromises in appearance (decreasing transparency and this increasing opacity) in the end product. No practical solution approach has yet been provided in the literature for the latter problem.

CN 107 955 212 relates to a completely biodegradable plastics film containing a thermoplastic starch, a biodegradable polymer such as poly(lactic acid) and other ingredients. The composition used for the production of blown films contains 20-80% by weight of such a poly(lactic acid), and the weight ratio of thermoplastic starch to poly(lactic acid) is preferably about 20 to 80 to 80 to 20. A possible transparency of the produced blown film is not mentioned.

The same applies to CN 103 159 984, which also discloses the use of poly(lactic acid) together with thermoplastic starch, the poly(lactic acid) being present here in an amount of 8-51% by weight. CN 103 159 984 does not disclose any possible transparency of the produced product, nor is any film or blown film mentioned.

Due to a lack of compatibility, the TPS qualities currently available on the market do not usually allow for use in a proportion of over 30-40% by weight in the compound or film, without the mechanical properties of the end products (films) suffering greatly. However, it would be desirable to produce films with a higher proportion (>40% by weight) of renewable raw materials such as TPS. The opacity associated with increasing starch content is an additional limiting factor. Especially in the packaging industry, the switch to bio-based and biodegradable materials is imperative for reasons of sustainability and to reduce the amount of long-lasting plastic waste. However, this sector also has specific requirements with regard to the transparency (or opacity) of film materials, as the transparency of packaging is a mandatory criterion for meeting customer expectations in a large number of applications (for example transparent outer plastic packaging, fruit and vegetable bags).

Various publications deal with the problem of opacity when adding TPS to biopolymer compounds. Different factors, such as the amylose/amylopectin ratio, type of plasticiser and plasticiser content, as well as the influence of fillers on transparency are discussed.

### SUMMARY OF THE INVENTION

The object of the present invention is to overcome the above-mentioned disadvantages of the prior art and to provide a method for producing a compound or a film containing thermoplastic starch and a thermoplastic polymer, which compound can be used to produce transparent films by means of blown or flat film extrusion.

A film is a flat, thin material with a thickness in the range of 2-500 μm, with the film flexibility to be achieved being dependent fundamentally on the type of raw material used as well as on the film thickness.

The object is achieved in accordance with the invention by a method for producing a compound or a film containing thermoplastic starch, an alpha-hydroxycarboxylic acid ROHCOOH, wherein R denotes CH₂ or CH₃CH₂, in an amount of 0.1 to 5, preferably 0.1 to 3, particularly preferably 0.1 to 1% by weight, in relation to the thermoplastic starch, and a thermoplastic polymer, in which method the compound or the film is subjected to an additional heating step to 100-140° C. during or after its extrusion. Surprisingly, it has been found that the additional heating step according to the invention to 100-140° C. of a compound containing thermoplastic starch and a thermoplastic polymer allows a transparent film to be obtained in a subsequent processing step. However, the heating step which is mandatory according to the invention can also be carried out only after further processing of the compound, directly on the film. With regard to the addition of an alpha-hydroxycarboxylic acid ROHCOOH provided according to the invention, it has been found that exceeding the upper limit of 5% by weight (in relation to the thermoplastic starch) leads to a reduction in the service life of the compound/film produced due to decomposition and generally to a deterioration in the physical properties.

It is also preferred if the additional heating step after extrusion lasts at least 15 minutes, preferably at least 30 minutes, particularly preferably at least 60 minutes for the compound and at least 2 minutes, preferably at least 5 minutes, particularly preferably at least 60 minutes for the film. Surprisingly, it has been found that, by adding an alpha-hydroxycarboxylic acid, preferably lactic acid, it is possible to produce compounds which, when processed according to the prior art, optionally (in particular if the additional heating step has not already been carried out during the production of the compound) with a subsequent heating step to 100-140° C., preferably to 120-140° C., for at least 15 minutes, preferably at least 30 minutes, particularly preferably at least 60 minutes (for the compound), yield a transparent film. The additional heating step which is mandatory according to the invention can, as mentioned, also be carried out directly on the film only after further processing of the compound. Surprisingly, heating the described films to 100-140° C., preferably to 120-140° C., for a period of at least 2 minutes, preferably at least 5 minutes, particularly preferably at least 60 minutes, then also produces a transparent film.

Whenever the term “transparent” is used in the context of the present invention, it refers to a comparison with the untreated film material (or a film material produced from untreated compounds), with “transparent” being understood as an increase in transparency compared to the reference material. The measurement or calculation of transparency or opacity (cloudiness) has been dealt with in a very wide range of publications. An increase in transparency or a reduction in opacity is defined as a reduction in absorption (measured, for example, at a wavelength of 550 nm) that can be detected by spectroscopy compared to the corresponding reference material.

Preferably, the compound according to the invention contains, as thermoplastic polymer, a polymer selected from the group comprising polyolefins, polyamides, polyurethanes, polyesters and mixtures thereof. Preferably, the compound contains, as thermoplastic polymer, polyesters which are readily miscible with the TPS due to their viscosities. The polymers used may be biodegradable or non-biodegradable, the former being preferred. Adjustment of the compound properties, such as strength, is possible via the polymer blend. When using a thermoplastic starch produced according to the invention, it is even possible to provide a TPS content in the compound in the range of up to 65% by weight.

According to the present invention, the compound described can be produced in a) separate partial steps (1. starch plasticisation and 2. subsequent compounding with a thermoplastic polymer carried out in a separate apparatus), but the compound can also be produced b) in the course of a one-step process (starch plasticisation and compounding in a single step in one apparatus). According to the invention, transparent films can be obtained both on the basis of the compound produced in a) and on the basis of the compound produced in b).

While any thermoplastic starch can be used according to the invention, a thermoplastic starch produced by a particular method is particularly preferably used, in which method a mixture of starch with a polyol, preferably selected from the group comprising polyethylene glycol, mono- and disaccharides, sugar alcohols such as glycerol, sorbitol, erythritol, xylitol or mannitol and mixtures thereof, in an amount of from 10 to 25% by weight of the mixture, and of an epoxide, selected from the group comprising epoxidised plant oils, such as soybean oil, linseed oil, sunflower oil, rapeseed oil and mixtures thereof, in an amount of 0.1 to 6, preferably 1 to 4.5, particularly preferably 2.5 to 3.5% by weight of the mixture, is extruded. The formulation for producing thermoplastic starch (TPS) concerns, from both a processing and a materials point of view, the production of a thermoplastic starch with an optimised property profile. Starch, a plasticiser (10-25% by weight) and an epoxidised plant oil (0.1-6% by weight) are used as starting materials. The end product is cold water swelling to cold water soluble. For the production of thin-walled film materials (in the range of, for example, 10-50 μm thickness), it is important to distribute the TPS as finely as possible in the compound matrix. Surprisingly, it has been found that with a thermoplastic starch produced in this way, a TPS particle size of <5 μm in the polymer matrix can be achieved in order to avoid the formation of a micro-roughness (film surface) and the occurrence of associated mechanical weak points. The use of these TPS in the form of a finely distributed disperse compound phase in combination with, for example, degradable thermoplastic polyesters (the continuous phase) offers a simple possibility to increase the moisture resistance as well as to optimise the end product properties. In this way, the biodegradability of the end product can also be adjusted. The sustainable character of the end product can be enhanced by the increased proportion of TPS made possible by this. For the epoxy, it has been shown that the absorption capacity of the melt is exhausted at 6% by weight; a higher dosage leads to oily deposits on the product or on the equipment.

In any case, it is important to provide an additional heating step to 100-140° C., preferably to 120-140° C., for at least 15 minutes, preferably at least 30 minutes, particularly preferably at least 60 minutes (compound), or to 100-140° C., preferably to 120-140° C., for at least 2 minutes, preferably at least 5 minutes, particularly preferably at least 60 minutes (film), either during or after the production of the compound or, if no heating step is used during/after the production of the compound, after production of the blown film from the compound. Only through the additional heating step is it possible to modify in such a way that, surprisingly, a transparent film is obtained when producing a blown film from the compound. As demonstrated in Table 3, it is possible through this and through a corresponding additive (preferably lactic acid) to achieve a transparency or opacity that approaches the starch-free pure polymer (for example PBAT).

Starch:

The starch used for the production of thermoplastic starch may be any conventional tuber, cereal or legume starch, for example pea starch, maize starch incl. waxy maize starch, potato starch incl. waxy potato starch, amaranth starch, rice starch incl. waxy rice starch, wheat starch incl. waxy wheat starch, barley starch incl. waxy barley starch, tapioca starch incl. waxy tapioca starch, and sago starch. Starches of natural origin generally have an amylose content of 20 to 30% by weight, depending on the plant species from which they are obtained. According to the invention, starches rich in amylopectin, which have a significantly increased amylopectin content, or products containing an increased amylose content, also belong to this category. In addition to the natural starch types rich in amylopectin and high amylose types obtained by breeding measures, also starches rich in amylopectin or high amylose starches obtained by chemical and/or physical fractionation or produced by genetically modified plants may be used. Functionalised starches may also be used and are defined as follows:

Functionalised Starch:

The starch used for the production of thermoplastic starch may also be a functionalised starch; if the term “starch” is used in the present description and in the claims, it is also understood to mean a functionalised starch. For example, etherifications or esterifications also fall under the scope of functionalisation. In the following, some derivatisations are described which, alone or in combination with each other, may be provided for further derivatisation of starch derivatives. The type of derivatisation and the raw material basis of the starch used are very closely related to the specific field of application of the particular product. The methods for this are known per se. In particular, the focus here will be on the functionalisation in slurry, paste, (semi-)dry method and functionalisation by means of reactive extrusion.

In general, starch derivatives are divided into starch ethers and starch esters. Furthermore, it is possible to differentiate between non-ionic, anionic, cationic and amphoteric as well as hydrophobic starch derivatives, which may be produced by slurry, paste, semi-dry or dry derivatisation as well as by derivatisation in organic solvents.

Anionic and non-ionic functionalisation of starch includes those derivatives in which the free hydroxyl groups of starch are substituted by anionic or non-ionic groups. Starch may also be anionically functionalised by oxidative processes such as the treatment of starch with hydrogen peroxide or hypolye or by a laccase/mediator system.

In principle, anionic and non-ionic derivatisation may be carried out in two ways:

a) Functionalisation achieves an esterification of starch. Inorganic or organic, usually divalent, acids or salts thereof or esters thereof or anhydrides thereof are used as functionalising agents. Mixed esters or anhydrides may also be used. In the esterification of starch, this may also take place several times, so that, for example, distarch phosphoric acid esters may be produced. Preferably, the starch used in accordance with the invention is the result of an esterification with mono-, di- or tricarboxylic acids with an alkyl chain with 1 to 30 carbon atoms or a carbamate, particularly preferably an acylated, such as a succinylated, octenylsuccinylated, dodecylsuccinylated or acetylated carbamate.

b) During the course of functionalisation, the starch is etherified. Methyl, ethyl, hydroxyethyl, hydroxypropyl, hydroxybutyl, carboxymethyl, cyanoethyl, carbamoylethyl ether starch or mixtures thereof may be used. Cationic functionalisation of starches includes those derivatives in which a positive charge is introduced into the starch by substitution. The cationisation processes are carried out with amino, imino, ammonium, sulfonium or phosphonium groups. Such cationic derivatives preferably contain nitrogen-containing groups, in particular primary, secondary, tertiary and quaternary amines or sulfonium and phosphonium groups which are bound via ether or ester bonds.

Amphoteric starches represent another group. These contain both anionic and cationic groups, making their possible applications very specific. They are mostly cationic starches which are additionally functionalised either by phosphate groups or by xanthates.

Among the esters, a distinction is made between simple starch esters and mixed starch esters, the substituent(s) of the ester possibly being different: in the ester group RCOO—, the R group may be an alkyl, aryl, alkenyl, alkaryl or aralkyl group with 1 to 20 carbon atoms, preferably 1 to 17 carbon atoms, preferably with 1 to 6 carbon atoms. These products include the derivatives acetate (prepared from vinyl acetate or acetic anhydride), propionate, butyrate, stearate, phthalate, succinate, oleate, maleate, fumarate and benzoate.

Etherifications are largely carried out by reaction with alkylene oxides (hydroxyalkylation) containing 1 to 20 carbon atoms, preferably 2 to 6 carbon atoms, in particular 2 to 4 carbon atoms, in particular by using ethylene oxide and propylene oxide. However, methyl, carboxymethyl, cyanoethyl and carbamoyl ethers may also be prepared and used. An example of carboxyalkylation is the reaction of starch with monochloroacetic acid or its salts. Furthermore, hydrophobic etherification reagents, such as glycidyl ether or epoxides, should be mentioned in particular. The alkyl chain length of the reagents mentioned is between 1-20 carbon atoms, and in addition aromatic glycidyl ethers are also possible.

Examples of derivatisation with glycidyl ethers are o-cresol glycidyl ethers, polypropylene diglycol glycidyl ethers, tert-butylphenyl glycidyl ethers, ethylhexyl glycidyl ethers, hexanediol glycidyl ethers and neodecanoic acid glycidyl esters.

Another possibility of alkylation is alkylation via alkyl halides, for example via methyl chloride, dialkyl carbonates, for example dimethyl carbonate (DMC) or dialkyl sulfate, for example dimethyl sulfate.

The starches used for esterification, etherification and cross-linking, and also the chemically non-functionalised starches, may also be tempered (in slurry) or inhibited (dry or semi-dry reaction) by means of thermal-physical modifications.

Starches may also be functionalised by hydrophobing reagents. Etherified hydrophobic starches are obtained if the hydrophobic reagents contain a halide, an epoxide, a glycidyl, a halohydrin, a carboxylic acid or a quaternary ammonium group as functional group. For esterified hydrophobic starches, the hydrophobic reagent usually contains an anhydride. A hydrophobing of the starch may also be achieved by mixing a starch or a starch derivative with fatty acid ester.

All of the mentioned functionalisations of starch may not only be achieved by reacting native starch, but also by using degraded forms. The degradation processes may be hydrolytic (acid-catalysed), oxidative, mechanical, thermal, thermochemical or enzymatic. In this way, the starch may not only be structurally changed, but the starch products may also be made soluble or swellable in cold water.

Lastly, the starch may also be present as a graft polymer or graft copolymer, for example with products from the group of polyvinyl alcohols or polyesters.

Epoxidised Plant Oils:

From a chemical point of view, the epoxides used in accordance with a preferred embodiment of the present invention for the production of the TPS are cyclic ethers. Epoxides may form interactions with the hydroxy groups of starch. Epoxides also include, inter alia, the epoxidised oils, in particular plant oils, which are used in accordance with the invention. Due to their chemical structure, epoxides are unstable, i.e. the ring structure is opened and may react with the starch or, in combination for example with water, may react to form a diol. The opening of the epoxide ring may be catalysed by acids (for example carboxylic acids). Preferably, epoxidised plant oils such as soybean or linseed oil (ESBO, ELO) are used. Epoxidised linseed oil has a viscosity of approximately 900 mPas at 25° C. and an epoxide oxygen content of at least 8.5% by weight. Epoxidised soybean oil, on the other hand, has a viscosity of approximately 300-450 mPas (also at 25° C.) and an epoxide oxygen content of 6.5-7.5% by weight. The viscosity measurements carried out for the purpose of the present invention were each carried out in a viscometer according to EN ISO 3219.

Polyols:

According to a preferred embodiment of the present invention, the mixture used for the production of the TPS in the compound contains a polyol selected from the group consisting of sorbitol, erythritol, xylitol, mannitol and mixtures thereof, in a quantity of 10 to 25% by weight. These polyols are so efficient in the TPS as plasticisers (interaction with hydroxy groups) that processing may take place in the process window (low pressure, low torque). The polyols may also be added to the TPS as a syrup (solution in water), which facilitates the mixing into the melt, resulting in a more homogeneous TPS or even more homogeneous compounds and smooth films. Furthermore, these polyols have the advantage over glycerol that they are solid at room temperature, but are present as a melt during processing and may therefore have a plasticising effect.

Preferably, the mixture for production of the TPS in the compound as a polyol contains sorbitol or erythritol in a quantity of 10 to 15% by weight.

It is also favourable if the mixture for the production of the TPS in the compound contains the polyol in a quantity of 13 to 15% by weight of the mixture. It has been found that the proportion of polyol as plasticiser in the TPS should not be too high, otherwise potential problems in food contact may occur. The plasticiser could, for example, leak out if it is present in excess, but on the other hand a certain percentage of plasticiser must also be present in order a) to be able to process in the process window (pressure, torque) and b) ultimately to achieve the required film properties (extensibility, tensile strength).

According to a further preferred embodiment of the present invention, it is provided that the mixture for the production of the TPS in the compound contains epoxide to polyol in a ratio of 1:2 to 1:8, preferably 1:4 to 1:6, particularly preferably 1:5. In the range of 1:2 to 1:8, TPS processing is good (pressure, torque and cuttability of the melt for producing granules) and an increase in the bulk density is noticeable. A ratio of 1:5 ultimately fulfils all the required properties on the film, namely a tensile strength >10 MPa and an extensibility >300%.

It is particularly preferred if the mixture for the production of the TPS in the compound further contains an acid, preferably a carboxylic acid selected from the group consisting of citric acid, malic acid, acetic acid or tartaric acid, in a quantity of between 0.1 and 1, preferably between 0.1 and 0.5% by weight of the mixture. Such an acid acts both as an activating agent for the epoxide and as a processing aid, since it a) cuts the branch chains on amylopectin and thus increases the proportion of linear molecules. The behaviour of the polymer thus becomes similar to that of classic thermoplastic materials. b) Furthermore, during the course of the addition of the acid, a depolymerisation of the molecules at the glycosidic bond takes place. The effect of change in process conditions such as temperature, pressure and residence time may thus be better estimated. Carboxylic acids such as citric acid, malic acid, acetic acid or tartaric acid have proven to be effective for this purpose.

In the method according to the invention, it is preferably provided that the mixture for the production of the TPS in the compound is extruded at a temperature of 100-175° C., preferably in a twin screw extruder and at reduced pressure in the last portion of the extruder. In the specified temperature range, the raw material is thermally stable during continuous processing, and the twin-screw extruder enables efficient destructuring of the starch (breaking up of the crystallinity of the native starch) by forced conveyance. A reduced pressure in the last portion of the extruder is important for adjusting the water content of the TPS product; this affects the processability and should be between 4-6% by weight if possible.

A thermoplastic starch obtainable by one of the methods disclosed above, preferably has a bulk density of 70 to 85 g/100 ml. Thus, the thermoplastic starch produced in this way is considerably denser than a TPS produced without the use of an epoxide, for which purpose reference is also made to the attached FIG. 1, in which these differences are clearly visible. Determined bulk densities of produced thermoplastic starches are also shown in the attached FIG. 2.

Also provided according to the invention is a compound containing either a conventional thermoplastic starch or a thermoplastic starch produced as described above, extruded with at least one thermoplastic polymer and an alpha-hydroxycarboxylic acid ROHCOOH, wherein R denotes CH₂ or CH₃CH₂, in an amount of 0.15 to 5, preferably 0.1 to 3, particularly preferably 0.1 to 1% by weight in relation to the thermoplastic starch. If these compounds are subjected during or after their production to a heating step to 100-140° C., preferably to 120-140° C., for at least 15 minutes, preferably at least 30 minutes, particularly preferably at least 60 minutes, they can be used directly for further processing, for example on the film line, and transparent films are the result. Alternatively, such a compound containing either a conventional thermoplastic starch or a thermoplastic starch prepared as described above, extruded with at least one thermoplastic polymer and an alpha-hydroxycarboxylic acid ROHCOOH, wherein R denotes CH₂ or CH₃CH₂, in an amount of 0.1 to 5, preferably 0.1 to 3, particularly preferably 0.1 to 1% by weight in relation to the thermoplastic starch, are also used without a heating step on a film line, but in such a case the blown film produced from such compounds must then be subjected to said heating step to 100-140° C., preferably to 120-140° C., for at least 2 minutes, preferably at least 5 minutes, particularly preferably at least 60 minutes. Only after the heating step is a transparent film then obtained.

As already mentioned, a TPS produced as described above in the compound is particularly expedient for producing a transparent film by blown film or flat film extrusion. Surprisingly, it has been found that, during the production of such a film, the practically unavoidable smoking no longer occurs when using a TPS known from the prior art.

The above-mentioned mixtures with their individual components are processed into a thermoplastic melt in the extruder under temperature and shear action.

### DESCRIPTION OF THE FIGURES

The present invention will now be explained in more detail with the aid of the following examples and figures. Unless otherwise stated, percentages and ratios are always by mass.

FIG. 1 shows the improvement in transparency of a film of glycerol-TPS/PBAT 1:1, which is—from left to right—untreated, untreated but with the addition of lactic acid, and with the addition of lactic acid and after the heating step provided in accordance with the invention.

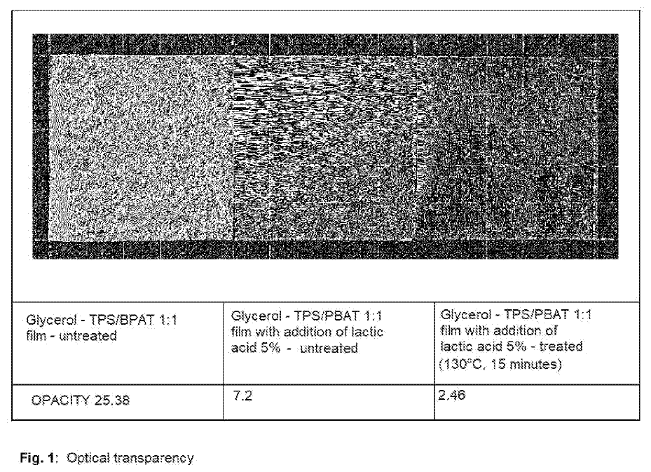

### DETAILED DESCRIPTION OF THE INVENTION

In the following tests, maize starch was introduced into an extruder as the starting raw material by means of solid dosing. Stearic acid is used (1% by weight) to improve the processability (reduction in torque). The mixture is processed in a twin-screw extruder using a temperature profile in the range 100-130° C. and at a speed of 250 rpm and granulated at the die plate by means of a hot die. The resulting material is water-soluble and can be incorporated as finely distributed TPS (disperse phase) into polyester melts for example (continuous phase) via a separate extrusion step. The thermoplastic starch is compounded together with polybutylene adipate terephthalate (PBAT) as polyester in a ratio of 1:1 in a twin-screw extruder.

Suppliers:

Sorbitol, glycerol, stearic acid—Brenntag, AT

DL-lactic acid—Sigma Aldrich

PBAT—BASF

ESBO—Hobum, AT

Citric acid—Jungbunzlauer, AT

Machine Types:

Extrusion (TPS and compound): Theysson TSK 30, 28D, 7 zones

Blown film line: OCS BFT400V3

The opacity of the pure carrier polymer, such as pure polyester (as a continuous compound phase), is used as the threshold value for the increase in transparency provided in accordance with the invention. To explain this, the following table 1 shows the opacity comparison of a film consisting of pure polybutylene adipate terephthalate (PBAT, Ecoflex) with a film consisting of a mixture of PBAT and glycerol-plasticised TPS (mixture 1:1) and with a film consisting of a mixture of PBAT and glycerol-plasticised TPS with addition of lactic acid (mixture 1:1):

TABLE 1
Comparison of opacity on film materials without thermal treatment

| | PBAT film | | |
|---|---|---|---|
| | (thickness 65 | | PBAT/glycerol-TPS |
| | μm) | PBAT/glycerol-TPS 1:1 | 1:1 film, TPS 5% with |
| Comparison | Reference | film (40 μm) | lactic add (50 μm) |
| Absorption | 0.30 | 1.02 | 0.36 |
| (wavelength 550 nm) | | | |
| Conversion with | 4.60 | 25.38 | 7.20 |
| reference to film | | | |
| thickness*) OPACITY | | | |

*) the correlation between absorption and layer thickness via the extinction coefficient according to Lambert-Peer was verified in the following test:
$A = log 10 \frac{I 0}{I} = ɛ \cdot \vert \cdot c$ (where ε = extinction coefficient, | = layer thickness, c = concentration −> the opacity-causing factor in this case is the starch - since the starch content was kept constant in the tests, the factor c is neglected or not considered separately).

TABLE 2
Influence of film thickness on ε · c

| Sample thickness PBAT/glycero- | | |
|---|---|---|
| TPS 1:1 film with lactic acid | Absorption = | Comparison |
| (mm) = \| | A | ε · c |
| 0.050 | 0.360 | 7.2 |
| 0.100 | 0.720 | 7.2 |
| 0.150 | 1.080 | 7.2 |
| 0.200 | 1.420 | 7.1 |

Table 3 below shows the various results after the thermal treatment provided in accordance with the invention, in this case of the films, at 130° C. for a duration of 15 minutes:

TABLE 3
Comparison after thermal treatment of films at 130° C. for 15 minutes

| | PBAT film | PBAT/glycerol- | PBAT/glycerol-TPS |
|---|---|---|---|
| | (thickness | TPS | 1:1 film, TPS with |
| | 65 μm) | 1:1 film | 5% lactic acid |
| Comparison | Reference | (40 μm) | (50 μm) |
| Absorption 550 | 0.16 | 0.46 | 0.12 |
| (wavelength nm) | | | |
| Conversion with | 2.42 | 11.38 | 2.46 |
| reference to film | | | |
| thickness*) | | | |
| OPACITY | | | |

Table 4 shows the properties of film materials (before and after thermal treatment) based on compounds consisting of PBAT and various thermoplastic starches, the difference being the plasticiser used for TPS production.

TABLE 4
Material properties of film materials based on TPS and the polyester Ecoflex
from BASF, DE (compounded 1:1), wherein different plasticisers in
comparable proportions (13% by weight of each of the substances listed in
the table in combination with 4% by weight solid sorbitol) were used in the
production of the TPS-the ″treatment″ described refers to heating the
produced films at 130° C. for a period of 15 minutes.

| | Opacity before | Opacity after |
|---|---|---|
| Plasticiser | treatment | treatment |
| Glycerol | 25.38 | 11.38 |
| Xylitol | 27.08 | 10.43 |
| Sorbitol | 21.17 | 16.72 |

Table 5 shows film materials containing 30% TPS (glycerol-plasticised and plasticised with water only). It can be seen that the transparency effect also occurs when plasticisation occurs with water only (an additional plasticiser is not absolutely necessary to achieve the effect).

TABLE 5
Films produced on the basis of water-plasticised and glycerol-
plasticised TPS in comparison (30% TPS in the mixture),
treatment 130° C., 15 minutes

| | Opacity before | Opacity after |
|---|---|---|
| Plasticiser | treatment | treatment |
| Glycerol | 18.93 | 10.76 |
| Water | 8.09 | 3.30 |

It can be seen that the opacity can be reduced by thermal treatment and, depending on the plasticiser used, approaches the opacity or transparency achievable on the reference film (pure PBAT, opacity untreated=4.6; opacity treated=2.42).

In the following examples concerning the production of a preferably used TPS, native starch (native maize starch, Maisita 21000) was mixed with a plasticiser (10-25% by weight), acid (0.1-1% by weight) and, of course only in the preferred examples, an epoxidised plant oil (0.1-6% by weight) in a one-step extrusion process, broken down and plasticised. For this purpose, the TPS was produced in a twin-screw extruder with vacuum degassing; all additives are added directly to the extrusion process via appropriate metering units. Processing takes place in a temperature range between 100 and 160° C. (a strong brown colouring may be seen above 160° C.).

The plasticiser may be presented in both solid and liquid form, and it is also possible to split the addition (i.e. addition partly in solid and partly in liquid form). The oil component is added untreated in liquid/pumpable form. The oil component is added untreated in liquid/pumpable form. The extrudates produced are suitable for further processing into compounds according to the invention (for example in combination with polyesters). Only on the basis of the compounds as well as the addition of an alpha-hydroxycarboxylic acid ROHCOOH, wherein R denotes CH₂ or CH₃CH₂ (preferably lactic acid), in an amount of 0 to 10, preferably 0 to 7.0, particularly preferably 0 to 4.5% by weight in relation to the thermoplastic starch, and the heating step to 100-160° C., preferably to 120-140° C., for at least 15 minutes, preferably at least 30 minutes, particularly preferably at least 60 minutes (compound) or to 100-160° C., preferably to 110-150° C., for at least 2 minutes, preferably at least 5 minutes, particularly preferably at least 60 minutes (film) either during or after production of the compound or after production of a blown film from the compound is it possible to produce transparent end products such as transparent film materials.

The use of plasticisers other than glycerol without the addition of epoxidised plant oil leads to a deterioration of the mechanical properties. The exclusive substitution of glycerol by plasticisers such as sorbitol, isosorbide or xylitol in a TPS is therefore not appropriate and, in the case of film materials based on TPS and polymer, has been shown to lead to losses in terms of the achievable mechanical material properties. Of course, according to the invention, a TPS produced using glycerol and without the addition of epoxidised plant oil can also be used; in fact any TPS can be used as long as the addition according to the invention of an alpha-hydroxycarboxylic acid ROHCOOH, wherein R denotes CH₂ or CH₃CH₂ (preferably lactic acid), is provided in an amount of 0 to 10, preferably 0 to 7.0, particularly preferably 0 to 4.5% by weight in relation to the thermoplastic starch, and either during or after production of the compound or after production of a blown film from the compound, said heating step is maintained at 100-160° C., preferably at 120-140° C., for at least 15 minutes, preferably at least 30 minutes, particularly preferably at least 60 minutes (compound), or at 100-160° C., preferably at 110-150° C., for at least 2 minutes, preferably at least 5 minutes, particularly preferably at least 60 minutes (film).

Only when an alpha-hydroxycarboxylic acid ROHCOOH, wherein R is CH₂ or CH₃CH₂ (preferably lactic acid), is added in the specified amount and the above heating step is provided can blown films with a surprising transparency be produced.

The table below shows the influence of the alpha-hydroxycarboxylic acid concentration, in this case the lactic acid concentration, on the opacity of the films described:

TABLE 6
Changes in opacity with increasing lactic acid content-after thermal treatment
of the films at 130° C. for 15 minutes

| | | | PBAT/glycerol- | PBAT/glycerol- | PBAT/glycerol- |
|---|---|---|---|---|---|
| | PBAT | PBAT/ | TPS 1:1 film, | TPS 1:1 film, | TPS 1:1 film, |
| | film | glycerol- | TPS with 1% | TPS with 3% | TPS with 5% |
| | (thickness | TPS 1:1 | lactic acid | lactic acid | lactic acid |
| | 65 μm) | film | (50 μm), | (50 μm), | (50 μm), |
| | Reference | (40 μm) | acc. to inv. | acc. to inv. | acc. to inv. |
| Absorption | 0.157 | 0.455 | 0.232 | 0.166 | 0.123 |
| (wavelength | | | | | |
| 550 nm) | | | | | |
| Conversion | 2.420 | 11.375 | 4.640 | 3.320 | 2.460 |
| with | | | | | |
| reference to | | | | | |
| film | | | | | |
| thickness*) | | | | | |
| OPACITY | | | | | |

In accordance with the present invention, it has surprisingly been found that the thermal treatment of a compound containing an alpha-hydroxycarboxylic acid (as compared to an untreated compound) also causes a reduction in the opacity or increase in the transparency of a film produced from the compound:

TABLE 7
Transparency values of films before the production of which only the
compounds were thermally treated (130° C. for a duration of one hour)

| | PBAT/sorbitol-TPS 1:1 | PBAT/sorbitol-TPS 1:1 film, |
|---|---|---|
| | film TPS with 5% lactic | TPS treated with 5% lactic |
| | add, (36 μm)-compound | add, (43 μm)-compound |
| Comparison | untreated | treated |
| Absorption | 0.552 | 0.427 |
| (wavelength | | |
| 550 nm) | | |
| Conversion | 15.333 | 9.930 |
| with | | |
| reference to | | |
| film | | |
| thickness*) | | |
| OPACITY | | |

In a preferred embodiment of the present invention, the addition of epoxidised plant oils (for example epoxidised linseed oil (ELO), epoxidised sunflower oil, epoxidised rapeseed oil or epoxidised soybean oil (ESBO) and mixtures thereof) during the production of the TPS, even when using, for example, sorbitol, results in the incorporation/mixing of the plasticiser into the TPS.

TABLE 8
Film based on TPS modified with 3% ESBO, 0.1% citric acid and 3% lactic
acid in the compound 1:1 with PBAT-the thermal treatment was performed
at 130° C. for a duration of 15 minutes (film thickness 75 μm)

| | Film untreated | Film treated |
|---|---|---|
| OPACITY | 5.61 | 2.97 |

The activation of the epoxide functionality in the epoxidised plant oils is promoted by the addition of acids. Carboxylic acids (which ideally may be produced on a sustainable basis) such as citric acid, tartaric acid, acetic acid, itaconic acid, malic acid or lactic acid can be used for this activation.

Methods of Analysis:

Film Thickness Determination by Means of Conventional Micrometer

Apart from the increased transparency (or reduced opacity), the superior material properties of films produced from TPS or compounds produced in accordance with the invention are also evident in an extensibility: >300% with a tensile strength of >10 MPa. A TPS content of 50% by weight and above can be used in the method according to the invention (a TPS content of 50% by weight was used for the above tests).

Determination of Opacity:

Direct insertion of the films into the beam path of the spectrometer and measurement in the visible range (wavelength 300-900 nm). Evaluation of the measurement result based on the absorption measured at a wavelength of 550 nm with reference to the film thickness.

The improved transparency or reduced opacity is reflected in a reduction of the parameter ε·c to a value of <10 (see optical comparison in the figures) at a TPS content of 50% in the film (with a minimum content of 35% pure starch).

1.-13. (canceled)

14. A method for producing a compound or film comprising:
mixing a thermoplastic starch, an alpha-hydroxycarboxylic acid ROHCOOH, wherein R is CH₂ or CH₃CH₂ in an amount of 0.1 to 5% by weight in relation to the thermoplastic starch, and a thermoplastic polymer to obtain a mixture;
extruding the mixture to form a compound or a film; and
heating the compound or film to 100-140° C. during or after extrusion.

15. The method of claim 14, wherein the alpha-hydroxycarboxylic acid is lactic acid.

16. The method of claim 14, wherein the compound or film contains the alpha-hydroxycarboxylic acid in an amount of 0.1 to 1% by weight in relation to the thermoplastic starch.

17. The method of claim 14, wherein the heating is after extrusion and lasts at least 15 minutes for a compound or at least 2 minutes for a film.

18. The method of claim 14, wherein the thermoplastic polymer is a polyolefin, polyamide, polyurethane, polyester, or mixture thereof.

19. The method of claim 14, wherein, the thermoplastic starch is obtained by:
mixing a starch, a polyol, and an epoxidised plant oil to form a mixture, wherein the polyol is in an amount of 10 to 25% by weight of the mixture and the epoxidised plant oil is in an amount of 0.1 to 6% by weight of the mixture; and
extruding the mixture.

20. The method of claim 19, wherein the polyol is polyethylene glycol, a monosaccharide, or a sugar alcohol.

21. The method of claim 20, wherein the polyol comprises glycerol, sorbitol, erythritol, xylitol, and/or or mannitol.

22. The method of claim 19, wherein the epoxidised plant oil comprises soybean oil, linseed oil, sunflower oil, and/or rapeseed oil.

23. The method of claim 19, wherein the amount of epoxidised plant oil is 2.5 to 3.5% by weight of the mixture.

24. The method of claim 19, wherein the polyol comprises sorbitol or erythritol in an amount of 10 to 15% by weight of the mixture.

25. The method of claim 19, wherein the mixture comprises epoxidised plant oil to polyol ratio of 1:4 to 1:6.

26. The method of claim 19, wherein the mixture further comprises an acid in an amount of 0.1 to 1% by weight of the mixture.

27. The method of claim 26, wherein the acid comprises citric acid, malic acid, acetic acid, and/or tartaric acid.

28. The method of claim 26, wherein the mixture comprises the acid in an amount of 0.1 to 0.5% by weight of the mixture.

29. The method of claim 19, wherein the mixture is extruded at a temperature of 100-175° C.

30. The method of claim 29, wherein the mixture is extruded in a twin-screw extruder with a separate vacuum zone in which degassing takes place by applying negative pressure.

31. The method of claim 14, wherein extruding the mixture comprises using blown or flat film extrusion to produce a transparent film.

32. A method comprising:
obtaining a compound produced by the method of claim 14; and
using the compound to produce a transparent film.

33. The method of claim 32, wherein the transparent film is produced by blown or flat film extrusion of the compound.
